(19) United States
(12) Patent Application Publication
(10) Pub. No.: US 2016/0094107 A1
(43) Pub. Date: Mar. 31, 2016

(54) PORTABLE APPARATUS FOR GENERATING ELECTRICAL ENERGY

(71) Applicant: DECIWATT LIMITED, London (GB)

(72) Inventors: Martin Philip RIDDIFORD, London (GB); James William REEVES, Twyford, Berkshire (GB)

(21) Appl. No.: 14/890,405

(22) PCT Filed: May 30, 2014
(86) PCT No.: PCT/GB2014/051649

§ 371 Date: Nov. 10, 2015

(30) Foreign Application Priority Data
Jun. 3, 2013 (GB) 1309839.7

(51) Int. Cl. H02K 7/18; F03G 3/00

(52) U.S. Cl. CPC H02K 7/1853; F03G 3/00

(57) ABSTRACT

A portable apparatus if provided for generating electrical energy. The apparatus has an electrical energy-generating device for generating electricity in response to input mechanical action, and a gravity powered drive for supplying the said mechanical action to the electricity-generating device by the descent of a suspended mass under the force of gravity. A protection system is provided to prevent a drive force, experienced by the electrical energy-generating device due to the input mechanical action, from exceeding a predetermined threshold as a result of an overload condition. The protection system may perform the dual function of physically protecting the electrical energy-generating device whilst also providing clear feedback to the user that the apparatus is subjected to an undesirable overload condition.

### FIELD OF THE INVENTION

The present invention relates to a portable apparatus for generating electrical energy, in particular having a protection system to prevent an excessive force or operational speed from damaging the apparatus in the event of an overload condition.

### BACKGROUND TO THE INVENTION

It is estimated that there are over 1.5 billion people in the world that do not have reliable access to mains electricity. In the hours of darkness these people typically rely on combustible fuels such as kerosene for a source of energy, in particular for lighting their homes or places of work. Over the last few decades there have been significant advances in photovoltaic (PV) cell technology in particular and this is seen as a potential replacement for biomass fuels. However, PV cells require a battery or analogous storage device for the generated electricity since of course they are only able to function during daylight. A PV cell and battery system is simply far too expensive to threaten the use of kerosene as a fuel source for providing light. Typically the people reliant upon kerosene survive on very low incomes which make many technological alternatives economically out of reach. Kerosene remains in ubiquitous use despite the long term health dangers associated with its combustion products, the dangers of fire caused by the use of a flame for illumination, and the impact upon climate change of burning such a fuel on a massive scale.

In this context we have previously developed a very low cost, reliable and “pollution free” solution to this problem in the form of a gravity-powered electrical energy generator. With this solution a raised weight is allowed to descend under the force of gravity, the action of which, via a gear system, turns a small electrical generator which powers an LED. An example of such apparatus is described in WO2011/045606A1.

It will be understood that such an electrical-energy generator must therefore be produced at very low cost and yet be capable of withstanding repeated use in challenging environments by users who are not familiar with such devices and thus may not understand how to prolong the life of such apparatus by carefully following operational instructions.

In such apparatus the intricate mechanical system for converting the slow descent of a significant mass into a high speed drive for a motor must be highly efficient. Typical drive systems have fixed, rigid relationships between the components to efficiently transfer energy. For example gearboxes are usually made from rigid housings, often made from metal, rigidly holding gears in a fixed relationship. Pulley systems work in a similar manner. A block and tackle is an example of an arrangement of pulleys that is designed to facilitate the lifting of a weight, where any elasticity or slippage in the system is avoided at all costs.

Each of these drive systems can fail catastrophically when overloaded. In the case of a weight driven step-up gearbox, hanging from a fixed point, this might lead to stripping the gears or the weight becoming detached and falling freely, possibly causing injury. Overloading can occur if too much weight is applied to the gearbox, or if the weight is lifted and dropped, which creates a large momentary increase in the stress on the gears. In such systems, it may be thought by a user that extra weight loading might be beneficial, to generate more power for instance. However every system will have a safe operational load beyond which it may be dangerous to use.

In the context of a gravity-powered electrical energy generator such susceptibility to malfunction as a result of an overload is highly undesirable since such a generator may represent a significant investment for its owner and there is a need to ensure that it may be used reliably for years. It is in this context that the present invention has been developed.

### SUMMARY OF THE INVENTION

In accordance with the invention we provide a portable apparatus for generating electrical energy, the apparatus comprising:
a. an electrical energy-generating device for generating electricity in response to input mechanical action;
b. a gravity powered drive for supplying the said mechanical action to the electricity-generating device by the descent of a suspended mass under the force of gravity; and,
c. a protection system adapted to prevent a drive force experienced by the electrical energy-generating device due to the input mechanical action from exceeding a predetermined threshold as a result of an overload condition.

We have therefore produced a significant leap forward in such apparatus by the design and development of a protection system which prevents the drive force exceeding a predetermined threshold as a result of an overload condition.

This concept is applicable in principle to any form of portable gravity powered electrical energy-generating device, in particular in which one of a number of different methods is possible for converting the gravitational potential energy of the descending mass into electrical energy. Typically such a method involves an electrical energy-generating device which comprises a gear train for converting a relatively low speed input from the gravity powered drive to a relatively high speed output. The electrical energy-generation function itself will typically be enabled by electromagnetic induction as in the form of an alternator, dynamo or motor (operated in reverse). However the protection system would also find benefit in protecting an electrical energy-generating device which functioned according to a different principle such as piezoelectricity.

The protection system is caused to operate in the event of an overload condition. Such a condition may be represented by the application of a mass to the gravity powered drive which is in excess of a predetermined magnitude, by applying an external additional force to the drive system (such as pulling down on the mass or its support), the uncontrolled descent of the mass (such as if it is dropped) or when there is insufficient electrical load on the electrical energy-generating device (an overspeed situation). In fact, the conditions under which an overload condition exists may be dependent upon an operational state of the device. Thus an overload condition may exist in the form of overspeed in the event that an insufficient electronic load, such as an open-circuit condition, is applied to the electrical energy-generating device. Thus, a “normal” operational weight may cause such an overspeed to occur if the electronic load is removed and the weight drives the electrical energy-generating device up to a speed at which damage may occur. An overload condition could be represented by one or more of these situations occurring simultaneously. The overload condition may therefore represent a temporary condition (lasting less than a few seconds: for example if the mass is dropped whilst lifting it, or the electrical load is removed by disconnecting a powered device temporarily), or a more sustained condition in which the applied mass is simply too massive, a light powered by the device “blows”, or an exclusively powered device is permanently removed.

Optionally the protection system may operate by at least partially decoupling the mechanical drive from the electrical energy-generating device. It may be advantageous for partial rather than complete decoupling since in certain overload conditions a full decoupling would potentially cause the mass to fall (unless otherwise slowed by an additional mechanism) which may present a safety risk to a user.

The protection system may comprise a number of different components and in the case of multi-component system these may be positioned at different locations within the apparatus. For example, at least part of the protection system may be positioned between the gravity powered drive and the electrical energy-generating device, including within one or each of the drive or device. The protection system may sit between the drive and the device in such a situation where it is the device that poses the highest risk of damage during an overload condition. The protection system may comprise a frictional mechanism for causing a reduced drive force to be provided to the electrical energy-generating device during the overload condition. Such a mechanism may include one or each of a clutch mechanism or brake whereby the additional unwanted energy is dissipated as heat through the action of friction during slipping of the clutch or brake caused by the overload. A biased ratchet system could also be used for this purpose, the action of the ratchet producing an audible indication of the overload.

Furthermore, at least part of the protection system may be positioned at or adjacent a coupling point of the mass. In addition or alternatively, the apparatus may have a housing comprising an attachment member for attaching the apparatus to a support when in use (such as a beam in a dwelling or other structure), and wherein at least part of the protection system is positioned at or adjacent the attachment member. In such cases the protection system may comprise a resiliently biased member. Such a member may be formed from an elastomer or a spring (of various types although a coiled spring provides a compact form). The resiliently biased member is well suited to providing protection against the dropping (uncontrolled falling) of the weight but not an overweight condition. However, the same resiliently biased member which moves physically in the event of an overload condition may cause the operation of a switch so as to activate the protection circuitry in an electrical version of the protection system (described later). These additional parts may provide some dampening of the effect of rapidly increasing forces (as may be the case if the mass which powers the apparatus were dropped) thereby providing some protection from temporary overload conditions. Nevertheless they have a limited ability to protect from sustained overload conditions.

Another possibility which may also be used in addition to any of the above is the use of an extendable coupling comprising a coupling housing and a length of flexible material, configured to allow the controlled separation of a first part of the apparatus attached to one end of the flexible material with respect to a second part of the apparatus attached to the coupling housing in response to the overload condition. Hence with this approach, if the overload condition occurs then flexible material deploys so as to separate the respective parts. For example this may cause the lowering of an excessive mass to the floor or the dropping down of the electrical energy-generating device with respect to its position of attachment to a beam or other support. Such an extendable coupling could be effected by the use of a clutch which causes the flexible material to be deployed when in the overload condition. This is particularly useful if the extendable coupling comprises a spool of the flexible material. Alternatively long coil spring may be used to achieve a similar effect. This might be held in its housing by a resilient detent for example which is deflected by the application of an excessive mass thereby allowing the spring, to which the mass is attached, to deploy. Whilst the simplest arrangements may require a manual reversal of the deployment of the flexible material it is contemplated that some form of automatic “wind in” mechanism may be used when the overload condition is removed.

Another approach to the implementation of a protection system is one in which the protection system comprises protection circuitry electrically connected to the output of the electrical energy-generating device, the protection circuitry being configured to operate when in the overload condition so as to increase the voltage of the electrical load or remove the load (open circuit) thereby allowing the electrical energy-generating device to operate at a speed in excess of that at which it operates under normal conditions. Provided that the electrical energy-generating device is capable of operating at such speeds then this protection system operates by reducing the mechanical stress within the electrical energy-generating device, in particular in any gear train forming part of such a device.

The protection circuitry is preferably caused to switch into a protection mode in which the operational speed of the device is increased beyond a normal speed to a higher protective speed. The protection circuitry may comprise a physical switch and a warning device (such as an LED and/or buzzer) connectable to the output of the electrical energy-generating device in response to the switch being operated. The warning device may be connected in series with a resistor to allow control of the current within the protection circuitry. Typically the switch is operable to connect the warning device to the electrical energy-generating device when in a first position. A single pole double throw switch may be used for this purpose. The switch is typically adapted to adopt the first position when the apparatus is in an overload condition. In such a situation the overload condition may cause the operation of the switch by a mechanical movement within the protection system. The switch may be operable to connect an operational circuit to the electrical energy generating device when the switch is in a second position. Such an operational circuit may be that which represents the “normal” function of the circuitry, for example to light a task light or to power a device through the terminals of the unit. The “protection” and “normal” parts of the overall circuit may be represented by parallel-connected circuits across the electrical energy-generating device.

Since the electrical potential difference across the output of the device is generally representative of the speed of operation of the device (and the current is generally representative of the torque), then an electronic switch which is voltage dependent may be used to efficiently operate the protection circuitry. Conveniently a zener diode provides such a voltage-dependent switch. Hence, the protection circuitry may comprise a zener diode and a warning device connected to the output of the electrical energy-generating device as part of the protection circuitry. Preferably the protection circuitry comprises a warning LED which is caused to operate in the overload condition so as to signal the existence of the overload condition to the user. Again, some other form of warning may be used, such as a buzzer for example. Preferably the protection circuitry is adapted such that current flows through the protection circuitry when an electrical potential difference across the electrical energy generating device exceeds a predetermined threshold. This allows an electrical switching function to be provided. However, preferably the apparatus further comprises a physical switch operable to connect an operational circuit to the electrical energy generating device. Such a physical switch may be positioned so as to electrically isolate the “normal” operational circuit from the electrical energy-generating device. Thus the protection circuitry having electronic switch (such as a zener diode) may be permanently connected across the device, with the physical switch being operable in an “ON/OFF” sense. This allows the protection circuitry to operate when there is a “no electronic load” condition (even when using the “correct” mass to drive the unit) and also ensures operation of the protection circuitry when an excessive mass is applied.

The apparatus may be embodied practically in a number of different designs. However, it is desirable that such designs produce a compact and rugged product that is capable of withstanding extended use by unskilled users in various environments.

It is particularly advantageous that the design of the apparatus provides a compromise between having rugged reliable components capable of withstanding significant mistreatment on the one hand and providing clear and rapid feedback to alert the user of an overload condition on the other. Long term reliability of the device is therefore provided by a protection system which performs the functions of physically protecting the apparatus, particularly the electrical energy generating device (and associated relatively delicate gear train for example) and providing feedback to a user which causes the user to operate the apparatus only in the manner intended. It will be appreciated that many such users will neither consult written instructions nor be provided with any tuition upon the use of the apparatus and therefore the apparatus is advantageously designed to be intuitive in its usage and provide clear feedback to correct unwanted usage behaviours.

Generally the electrical energy-generating device and gravity powered drive are provided as a unit which may be suspended from a support such as a hook or tied to a beam. Whilst the gravity powered drive may utilise a wire to suspend the mass, preferably a flexible sprocket belt is used for this purpose, this meshing with a sprocket within the gravity powered drive of the unit. The mass (or masses where a “counterweight” is employed) may be specifically supplied with the apparatus. However, for ease of use in remote locations a more versatile solution is the provision of a bag (or bags) which is coupleable to the gravity powered drive, this bag being of a volume such that when filled with soil, sand or stones for example an approximately known predetermined mass is generated which provides a force of the expected approximate magnitude for operation of the apparatus. The counterweight assists the user in resetting the apparatus for reuse, although a similar function may be performed by attaching the primary weight to a rewindable spool (analogous to a flexible tape measure, possibly including a self-rewind for example).

The invention may be embodied in kit form, such a kit comprising a portable apparatus as discussed, a sprocket belt to form part of the gravity powered drive; and a primary weight bag and a counterweight bag for attachment to respective ends of the sprocket belt.

### BRIEF DESCRIPTION OF THE DRAWINGS

Some examples of a portable apparatus for generating electrical energy according to the invention are now descripted with reference to the accompanying drawings, in which:

FIG. 1 is a schematic illustration of a first example apparatus according to the invention;

FIG. 2 shows a sprocket belt for use with the invention in more detail;

FIG. 3 shows an example of a protection system;

FIG. 4 shows an additional component for use in the protection system arranged at an attachment position between the apparatus and a support;

FIG. 5 shows a further additional component for use in the protection system arranged at a position between the sprocket belt and the weight;

FIG. 6 shows a second example apparatus having an electrical protection system implemented using a single pole double throw switch;

FIG. 7 shows a third example apparatus having an electrical protection system implemented using a hold closed switch;

FIG. 8 shows a circuit diagram for implementing the second example; and,

FIG. 9 shows a circuit diagram for implementing the third example.

### DESCRIPTION OF EXAMPLES

We now describe a number of examples of the invention. Each of these is particularly suited to implementation in a low-cost portable unit for, typically, domestic use in environments which are absent either a reliable, environmentally-friendly or economical source of electrical power.

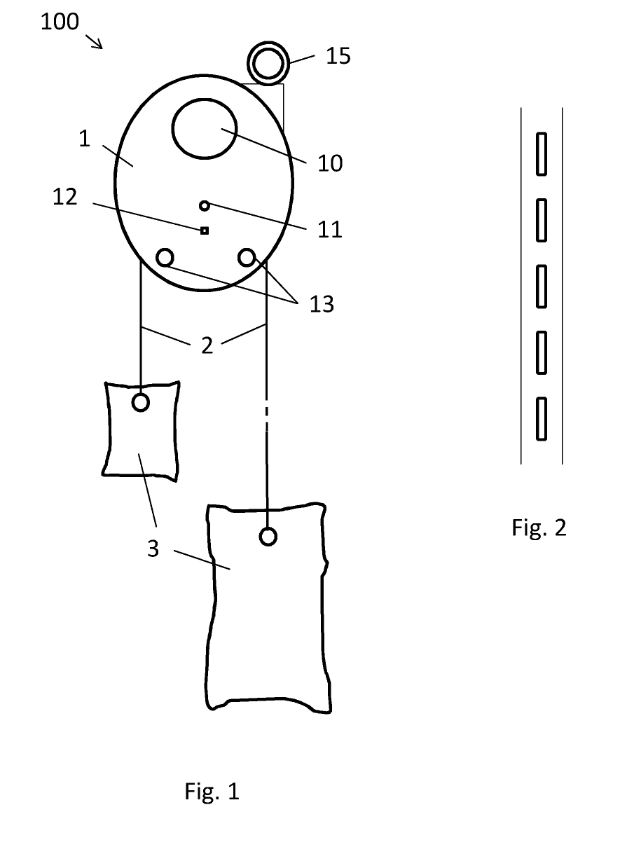

Our earlier patent publication WO2011/045606A1 provides examples of gravity-powered electrical energy generators which may be used in association with the present invention. The contents of WO2011/045606A1 are incorporated herein by reference so as to provide the principles of construction for the assembly of a gravity-powered electrical energy generator which may be adapted for use with the present invention. FIGS. 1 and 2 of WO2011/045606A1 and the accompanying description in paragraphs [26] to [36] of that document discusses one example of a unit which supplies electrical energy to an LED 40 from the terminals of an electric motor 20 which is driven via a gear system by the descent of a weight attached to a cord 6 wound around a drum 2 to which the gear system is coupled.

The design disclosed in WO2011/045606A1 has been subsequently enhanced in a number of ways so as to produce a more efficient, compact and robust unit suitable for reliable and regular use in remote parts of the world.

### First Example

FIG. 1 is a schematic representation of a first example of the enhanced design. This takes the form of a system 100 provided in a three-part kit form. The system has a generator unit 1, a sprocket belt 2 and a weight system 3. The generator unit takes a generally ellipsoidal form in two dimensions and is approximately of a constant thickness in the third dimension. It is formed from a two-part housing (generally forming front and rear “halves” of the unit, the front half being illustrated in FIG. 1) manufactured from a rugged plastics material. On the front face of the front half of the housing is located a power control dial 10 which may be rotated manually by a user so as to control the electrical power output of the unit. A high luminosity LED 11 is located approximately centrally and below the power control dial 10 in a region of moulding of the housing material (not shown) so as to direct the light from the LED in a wide cone directly outwardly and downwardly away from the unit. Below the LED 11 is located an ON/OFF switch 12. Adjacent the lower periphery of the front face and straddling a vertical centreline of the unit 1 are positioned two power terminals 13 providing positive and negative polarity connectors for the supply of electrical direct current to a device at the choosing of the user.

When no peripheral device(s) are connected to the terminals 13, the electrical power generated by the generator unit 1 is provided to the LED 11. The power dissipation in the LED 11 is controllable by the user by suitable rotational positioning of the dial 10. For example rotating the dial 10 fully in one direction maximises the power output which, in turn, causes the weight (to be described below) to descend at its maximum operational rate. This generates the highest level of illumination (useful for lighting a dwelling or other structure to enable routine tasks for the inhabitants) from the LED 11 although the operational time is reduced due to the higher energy consumption. Lower levels of illumination may be achieved by rotating the dial 10 in the opposite direction so as to effect a longer duration of lighting as might be needed for a “night light” for example. In the event that a device or other electrical circuitry is connected to the terminals 13, the power is provided to that device or circuitry via the terminals. A simple switch may be used to provide power to one or each of the terminals 13 and LED 11.

The generator unit 1 is designed to be suspended from an eyelet 15 which allows it to be placed securely upon a suitable hook or lashed to a beam or other elevated point using a thin rope or tie for example. The sprocket belt 2 is formed from a strong and durable plastics material such as polypropylene. This is effectively an elongate and thick tape having a number of regularly spaced rectangular apertures. These are shown more clearly in FIG. 2. The belt 2 is threaded through a path within the unit 1 and the apertures are entrained with the teeth of a sprocket wheel coupled with a gear train within the unit. The weight system 3 comprises two strong bags of different sizes so as to form a counterweight 20 and a primary weight 21, each bag being open at one end and having an eyelet positioned centrally adjacent the open end for attachment to the sprocket belt 2.

Each bag is filled with a readily available material when in use, for example, soil, sand or stones. The relative volumes of the bags are designed such that, when full the bag for the counterweight presents a mass of about 0.8 kg whereas that of the primary weight has a mass of about 12.5 kg. The primary weight is coupled to the end of the sprocket belt 2 which hangs directly below the eyelet 15, whereas the counterweight hangs, laterally spaced, to an opposite side of the unit centreline and is attached to the opposite end of the sprocket belt 2. The electricity generation function of the unit 1 is driven by the difference in gravitational force upon the primary weight in comparison with the counterweight. The function of the counterweight is to allow the user to easily “wind” the generator unit up by simply lifting the primary weight vertically up to a start position just below the unit. During this procedure the weight of the counterweight 20 draws the sprocket belt 2 through the unit and a ratchet mechanism coupled to the sprocket within the unit allows the sprocket belt to rotate freely in a first direction. Once the user gently lets go of the primary weight 21, the ratchet engages and couples the sprocket to the rest of the internal gear train so as to start operating the gear train and therefore begin generating electricity.

The fastest way to recharge the system is to simply lift the primary weight 21. In practice the unit is normally positioned as high as possible above the ground and yet within reach of the user when standing on the ground, for example at a height of around 2 metres. Much greater heights may be used if the system is recharged by pulling down on the counterweight. In this case a longer sprocket belt (placing the counterweight itself in reach of the user) or a cord attached to the counterweight and in reach of the user may be used, enabling the unit itself to be suspended at greater heights so that it may produce electricity for extended periods.

There are design limitations placed upon the mechanism within the unit and in particular the gear train. For example it is desirable that the gear train operates quietly, is not subject to high rates of wear and is of low cost. Cost is a critical factor in producing a system which may be used by people in undeveloped areas of the world (such as parts of Asia and Africa) who survive typically on very low incomes. As will be appreciated, the force applied to the gear mechanism during use is substantial and, in order to meet the design requirements of the unit, it is particularly important that such a force is not exceeded.

There are a number of situations in which, in practice, the force applied to the sprocket belt 2 may exceed its design threshold. Such situations include:
a) Overfilling of the primary weight bag;
b) Pulling down on the primary weight during operation, for example to make the LED output brighter;
c) Children using the primary weight as a toy when in operation;
d) Dropping the primary weight during a “winding” (reset) operation.

Each of these circumstances may cause the generator unit 1 to be damaged irreparably, for example by gear teeth within the unit becoming “stripped” from their mountings. Further, it is possible that such damage to the unit 1 may cause an uncontrolled plummeting of the primary weight, since the unit is no longer able to dissipate the gravitational potential energy of the primary weight.

For these reasons the unit of this first example is fitted with a protection system whose primary function is to protect the unit from internal damage in the event of “overload” conditions in the form of a temporary or sustained application of a drive force which is in excess of predetermined thresholds (noting that the temporary and sustained condition thresholds may not be the same).

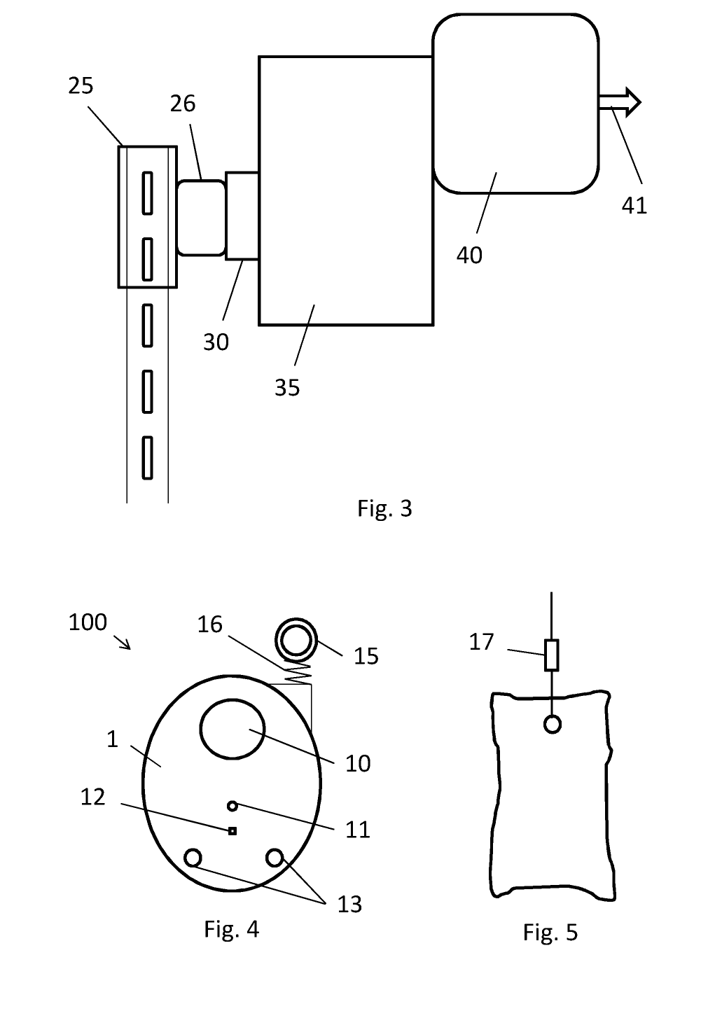

FIG. 3 is a schematic illustration of the first example protection system fitted to the generator unit 1. The sprocket belt 2 is shown engaged with the sprocket 25. The sprocket 25 is coupled directly with a clutch 26 which provides part of the protection system. The clutch 26 is coupled with a ratchet system 30 which transmits torque in one rotational direction only (due to the use of a ratchet ring and biased pawls for example), thereby allowing the lifting of the primary weight so as to reset the generator unit 1 for further use. The ratchet system couples the torque provided by the primary weight to one end of a high step-up gear train 35. The gear train may be designed in a number of different configurations in arrangements such as a sun and planet system. The gears in the gear train 35 are formed form a plastics material. We have found that a total gear step-up ratio of over 1:1000, and up to, say, around 1:8000, is useful in providing a practical unit. Due to the high rotational speeds generated at the output end of the gear train we have found that a smooth-rimmed wheel is beneficial for this “final” gearing, this meshing frictionally with a “conically” shaped gear which may be moved axially in response to a user operating the power control dial 10. As an enhancement of the original “conical” gear (described in WO2011/045606A1), this function is now provided by a rubber-edged wheel driving a polished plastic ‘cone’ (rather than a metal on metal arrangement) since this provides a more efficient solution, with a longer life span, with lower operational noise and reduced cost. The “conical” gear is implemented as a “stepped” cone (that is, a rod of decreasing diameter steps) in this first example.

The gear train 35 drives the drive shaft of an electrical motor 40 which is operated in a reverse mode so as to be used as an electrical generator. Since the motor 40 is a DC motor, a direct current electrical output is provided by the motor 40 as indicated by the arrow 41 and which is directed to the LED 11 and terminals 13.

The clutch 26 provides a critical function in the present example since it is engineered to slip frictionally in the event of an excessive force being applied to the sprocket belt 2. For example, if, using a normal mass for the counterweight but an overloaded mass of, say, about 15 kg, the clutch 26 is caused to slip. This frictional slipping causes a controlled and yet relatively swift descent of the primary weight 21 which in turn ensures that the torque transmitted through the gear train 35 is not sufficient to cause any damage to the gearing. The clutch provides protection to the gear train in the event of a sustained overload (such as overloading of the primary weight), however it will conveniently also operate in the event that other overload conditions occur, such as children pulling on the descending weight, or indeed if a user drops the weight prior to any slack in the sprocket belt 2 being taken up by movement of the counterweight and ratchet system 30.

As a further optional part of the protection system, the eyelet 15 may be coupled to the remainder of the unit via an eyelet biasing element 16 such as a spring or length of elastomer, each exhibiting some limited deflection only when properly loaded so as to provide for the dampening of temporary overloads, such as in the case of a dropped weight. This is illustrated in FIG. 4. Similarly, or in addition, a biasing element such as a spring or length of elastomer may be used adjacent or at the point of coupling with the primary weight 21. FIG. 5 shows the use of a length of elastomer for this purpose as a weight biasing element 17.

The above protection system, which optionally includes the additional features of either FIG. 4 or FIG. 5, functions mechanically so protect the gear train 35 in particular. One of the advantages of these approaches is that they are “reversible” in the sense that, upon removing of the overload condition, the generator continues to function as normal without further intervention. So, the clutch engages frictionally once more and the biasing elements return to their previous positions.

Each of the optional biasing elements could also be replaced, as a further option, by a spool of material which deploys in the event of an overload. For example, positioning such a spool at the position of the eyelet biasing element would cause the whole generator unit and attached weights to descend with respect to the eyelet 15 in the event of an overload. Such a spool might be designed to deploy to its full extent once activated or may be required to continue deploying provided the overload condition persists. A high strength cord, wire or tape could be used to deploy from the spool. Of course such spools could also be used in addition to the biasing elements if desired. However, unless an automatic rewind mechanism were provided (such as it used in a measuring tape reel), then such spool systems would require resetting manually or replacing entirely (in a “once only” version).

We have realised that, in addition to the above described mechanical methods of protecting the gear train 35 and motor 40, in the case of some overload conditions, in particular in the event of modest overloads, which may occur more frequently in practice, then there are benefits in employing “non-mechanical” methods for protection. These may be useful where the gear train and motor are capable at operating at speeds in excess of the normal maximum operational design speed, provided there is not such a high electrical load on the system. Thus the protection system may be provided with switchable circuitry in which, when an overload condition occurs, a circuit which provides a reduced electrical load is connected across the output 41 of the system. The switching of such a circuit may be provided by a physical switch which is activated by the movement of a biasing element for example. Each of the biasing elements 16 or 17 in FIGS. 4,5 respectively could be fitted with a small switch which operates upon the deflection of the biasing element reaching a certain magnitude. The eyelet biasing element may be more conveniently located for the use of such a switch due to its relative proximity to the rest of the generator unit 1. Here, the biasing element absorbs the shock of any initial application of the overload condition and the activation of the switch causes a reduced total electrical load to be connected across the output of the motor 40 thereby allowing the gear train and motor to operate at a higher speed whilst the overload condition persists. In the event of a dropped primary weight for example, the biasing element would absorb some of the initially damaging force, whilst the overload switching would cause the circuit to switch to the “protected mode” until any instability (such as bouncing) of the primary weight had dissipated after which the overload condition would be removed and the circuit would automatically regain its normal mode of operation with the higher electrical load.

As an alternative to mechanical switching, an electrical switching system may be provided whereby, in the event of the output current of the motor 40 exceeding a certain magnitude due to mechanical overload, then an additional warning LED (for example a red LED) may be operated.

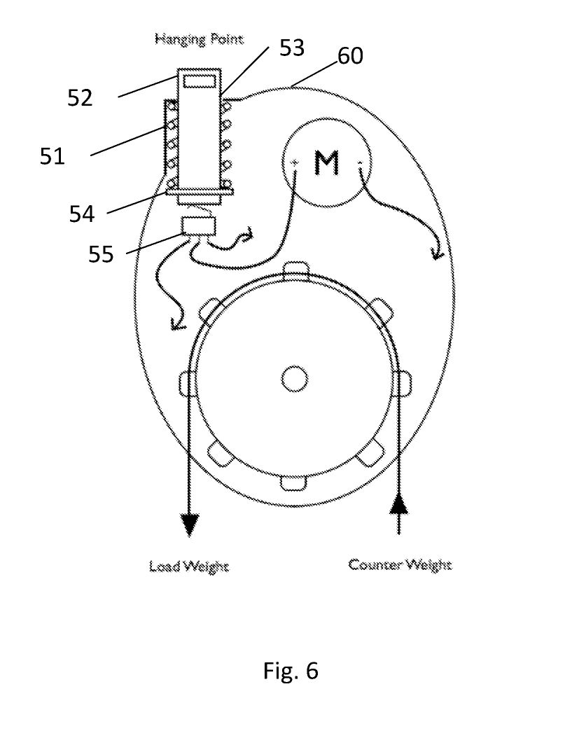

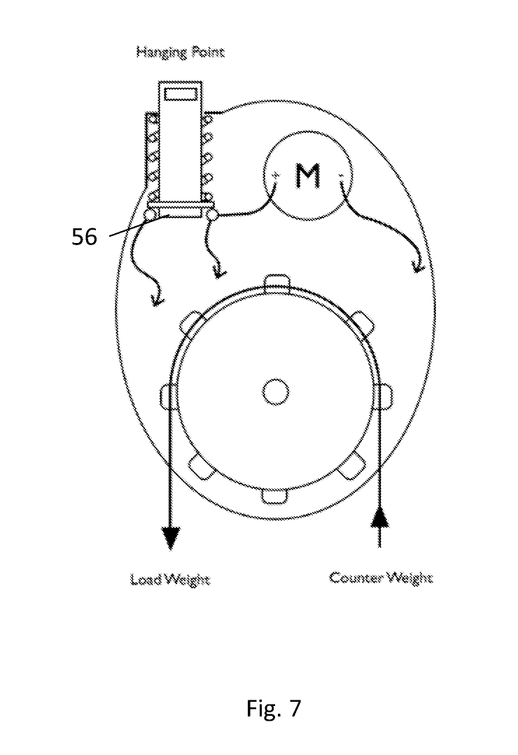

Two examples of apparatus having such electrical protection systems are now described in association with FIGS. 6 and 7 in the form of second and third examples of the invention. These examples share a generally similar mechanical design with that of the first example and all features described in association with the first example, including optional features, may be implemented with these two examples.

### Second Example

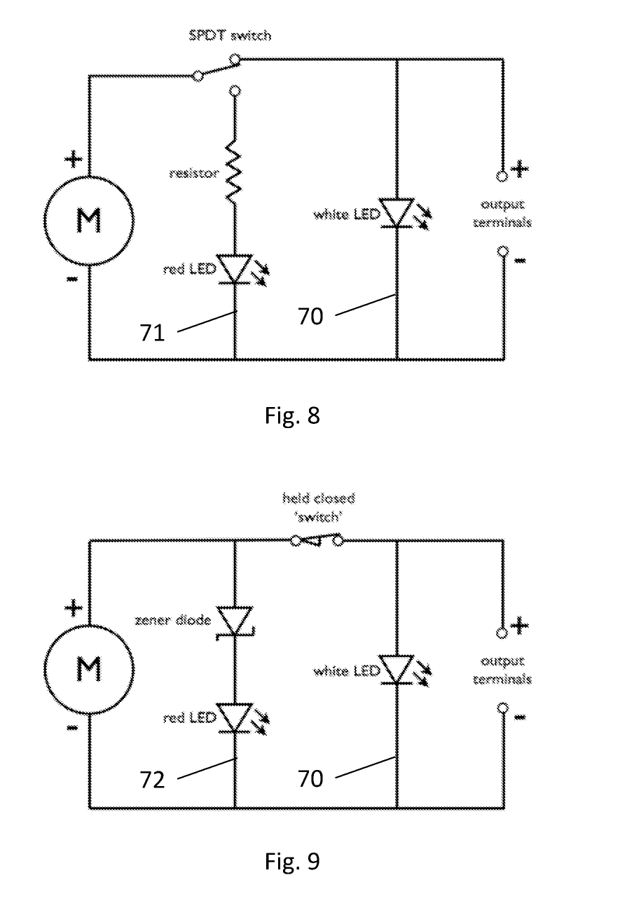

With reference to FIG. 6, the second example utilises an internal spring 51 at the hanging point 52, to reduce the magnitude of the peak force transmitted from shock loads to the gear teeth. The protection system is formed from the internal spring 51 in combination with circuitry illustrated in FIG. 8 to cause a speed increase in the gear train within the gearbox in the event of an overload condition, which reduces the duration of mechanical loading through each gear tooth. The speed increase is triggered by either a momentary shock load, or the application of a mass that is too massive and is achieved by removing the electronic load across the terminals of the DC generator (labelled as “M” in FIG. 6).

In this event, a secondary electronic load, which draws current at a higher voltage (thereby causing an increase in speed within the gear train) is applied across the terminals of the DC generator to prevent potentially damaging or dangerous runaway speeds of the falling mass, and a damaging overspeed in the gear train.

Referring to the mechanical arrangement in more detail, the internal spring 51 is provided as a coil spring inside the body of the device, through the “bore” of which a swivelling, generally cylindrical, ‘hanging turret’ 53 passes. The turret swivels about its elongate axis to allow the user to direct the on-board light (LED 11 of FIG. 1) in the direction they want. The turret has a larger diameter, circular rim 54 at its base, upon an upper surface of which the internal spring 51 is seated. The spring is trapped between this seat surface and a downwardly facing surface of a housing 60 of the unit, which has an aperture in it allowing the cylindrical turret 53 to be extracted through it by a “pull” force, while retaining the internal spring 51 inside the housing 60. This causes the spring to be compressed on extraction. The turret can be extracted up to a maximum length, at which point the solid length of the spring is reached as the spring attains a fully compressed state.

The turret 53 may be secured by passing a strong zip-tie through the eyelet 15 (see FIG. 1) at the top, which will be lashed around a ceiling joist or similar. There exists the option of using a rubbery/bungy type strap, in place of the zip-tie, if greater damping in the system is needed.

Preferably, the internal spring 51 is preloaded, during assembly, to the specific maximum force the generator is expected to be subject to in normal use, plus a small margin. In this example, a maximum driving weight to be used is 12.5 kg. The counter weight is 0.8 kg; the unit weighing 0.8 kg, therefore totalling 14.1 kg. The margin is 0.9 kg, so the preload on the spring is 15 kg of force in this first device (obviously this is entirely selectable by design).

This preload force on the spring is not essential, and the spring could be under a lighter, or minimal preload to give enhanced softness to the mounting. The trigger for the electronic protection circuit (to be described) would then actuate at some intermediate extraction distance of the turret. The full preload chosen for the present example offers a smaller overall geometry (as its internal travel is minimised) and it has a very predictable, easy to execute, trigger point.

The mechanical arrangement described above sets a precise trigger force for a second element of the protection system to come into effect: a change in the electronic load across the generator (a higher voltage load), and actuation of a warning signal (a secondary, red LED and/or buzzer for example) to alert the user.

The electrical configuration in this second example is shown in FIG. 8. This provides protection against shock loading and protection against the application of a weight that exceeds the maximum threshold (the overly massive mass).

Returning to FIG. 6, the mechanism for providing resilience at the hanging point is further provided with a single pole double throw (SPDT) micro-switch 55 positioned below it. The movement of the base of the turret 53 throws the switch between its two possible switch positions. The turret base presses upon the micro-switch 55 so as to hold the switch in one of its two positions when any extraction force is less than the predetermined maximum trigger force (equivalent to a mass of 15 kg here). A greater force causes switching to the other of the two positions.

FIG. 8 illustrates a circuit that provides the increase in the load voltage beyond the set trigger force.

In normal operation, the power from the DC motor M (or any generator such as that generally illustrated at 40 in FIG. 3) that is provided to the external terminals (or socket) and to the on-board, white LED lamp, will pass through this switch. The current passes through the main circuit branch 70 (which connects the LED 11 across the DC motor M and, in parallel with the LED 11, the terminals 13 for supplying an external device). If the turret 53 is extracted by a force exceeding the trigger value, by even a small amount, the circuit to the outlet and on-board LED lamp is broken, so no useful output is available to the user. This guards against excessive force being applied to drive an electronic device with more power than the unit can mechanically process.

In this second example, the extraction of the turret causes a switch-over (using the SPDT micro-switch 55) from the main circuit branch (70 in FIG. 8) to a protection circuit branch 71. The protection circuit branch is formed from a resistor in series with a red warning LED (and/or a buzzer). The presence of the series resistor raises the generator voltage at which the warning LED lights, causing the system to speed up. The switch-over function from one circuit branch to the other is needed in this circuit arrangement, as with this protection circuit the red LED would otherwise be lit dimly all the time, and deprive the main LED (“white LED”) of power during normal operation.

None of the units described in the examples discussed herein are limited to being used as a light only. They also have the potential to be used as a generator. A ‘no electronic load’ condition can occur when a particular unit is configured to optionally provide power for uses other than lighting, or when functionality is extended to provide more lighting configuration options, such as by connecting peripheral circuitry or devices to the terminals 13.

Switching off the on-board LED 11 is necessary when using certain types of external peripheral device, or accessory, which may be incompatible with the simultaneous provision of power to the on-board LED. External devices or accessories that benefit from the on-board LED being switched off include most radios, where the on-board LED can be caused to flicker as the power draw of the radio fluctuates, or any device with a higher voltage than the forward voltage of the on-board LED (typically around 3V), such as 5V USB output or battery charging. These different load voltages cannot be accommodated simultaneously without the inclusion of additional costly and inefficient power modification circuitry.

It may also be desirable, when using any of the examples as a light only, to have the option of either switching off the on-board LED, in order to direct all available power to an external task light or light string, or maintaining the on-board LED light, to share the power between the on-board LED and an external task light or light string. The desirable configuration modes for lighting would therefore be:
A) all power to the on-board LED,
B) all power to an external light or lights, and
C) power shared between the on-board LED and an external light or lights.

The “no electronic load” condition can arise when the device in configured to allow mode B: all power to the output terminals. This is the same mode that is needed when using the incompatible peripherals or accessories mentioned above.

Switching off the on-board LED 11 can be achieved manually by the user, with the inclusion of a simple external switch, but this presents the greatest risk of a high frequency of no-electronic-load conditions occurring. It can also be achieved automatically by the inclusion of the same simple external switch in combination with a switching socket (such as a DC socket or audio jack socket) through which connections to external devices pass. The external switch would then be selecting between a circuit that includes the on-board LED plus the socket in parallel, and a circuit that instead routes the connection to the on-board LED through the switched terminals of the switching socket, causing the circuit to the on-board LED to be broken upon insertion of a plug into the switching socket.

Mode A is then achieved by having no peripheral plugged in, mode B by inserting a plug into the socket with the external switch set to cut power to the on-board LED upon plug insertion, and mode C by having the same situation but with the external switch in the alternative position, so that connection to the on-board LED remains uninterrupted all the time and power is shared between it and the external peripheral.

Any peripherals or accessories that are incompatible with simultaneous powering of the on-board LED, would be powered successfully with the unit switched to mode B.

However, even with automatic switching, it is not possible to mitigate against a no-electronic-load condition arising when the facility for mode B is provided, as a plug inserted into a switching socket that is incorrectly wired to an accessory, or wired to nothing at all, will cut power to the on-board LED 11 when the device is in this mode, leaving no load across the generator. This condition also arises when a user simply switches off the external peripheral or accessory while it is being powered by unit, and may also occur in the rare event of a failure of the on-board LED.

These issues are addressed by the third example.

### Third Example

In the third example, the apparatus uses a similar turret approach at the hanging point although in this case the switch used is simpler (as shown in FIG. 7). A modified protection circuit is used which is illustrated in FIG. 9. This is arranged to provide protection against overload conditions in the form of not only momentary shock loads and excessive masses, but also overspeed conditions that can occur in the event of no other electronic load being present across the generator terminals. The circuit of the third example protects against these conditions, while also ensuring the unit is protected when the functionality of the unit is extended beyond a choice between either ambient light or ambient-plus-task-light options. Thus, this example provides the same functionality as the second example, and in addition provides protection against damaging overspeed conditions, that can arise in the event of there being no electronic load across the motor (generator).

In the third example a simpler mechanical switching arrangement is provided in combination with improved functionality in the protection circuit. In comparison with the protection circuit of FIG. 8, the resistor in the protection circuit branch is replaced with a zener diode. This protection circuit branch is permanently connected across the supply of the DC motor M and an “ON/OFF” function switch 56 connects the main circuit branch 70 in parallel with the protection circuit branch.

The ON/OFF switch 56 of FIG. 7 may be thought of as a simple “held closed” switch, since when in normal use it is held closed and the protection circuit banch and normal circuit branch are connected in parallel across the DC motor M. The switch 56 may be implemented with two simple metal contacts (such as pieces of sprung wire, as illustrated in FIG. 7 and a metal component to form the base of the turret (such as a washer), which will bridge across the contacts during normal operation to complete the circuit. This provides a low cost and reliable switch and is beneficial since no sophistication in switching quality or function is required by the circuit illustrated in FIG. 9.

When the electronic contacts at the base of the turret are broken, or open-circuit, due to a shock load or the application of a mass that is too massive, no electronic load is present across the generator terminals, as in the example of FIGS. 6 and 8. The generator, and entire gear train, is free to accelerate, causing the mass to fall faster. However, in the present example of FIGS. 7 and 9, this time, in parallel to the normal circuit branch 70, there is a protection circuit branch 72, which only comes into effect at a predetermined, higher voltage (speed).

This configuration of the protection circuit branch 72 consists of a zener diode in series with a red warning LED. Each circuit described in association with FIGS. 8 and 9 are very low cost, but the circuit of FIG. 9 has the cost advantage of not requiring a SPDT switch component.

The zener diode characteristics are such that it acts as a ‘block’, or behaves as if ‘open-circuit’, until a given voltage is present across it. At this threshold voltage, the zener diode suddenly allows current to flow through it, powering the red warning LED. The zener diode causes the voltage across the red warning LED to be less than the voltage created at the generator terminals (which is now high), as the zener diode has a voltage drop across it, equal to its trigger voltage.

For example: the ‘switch’ 56 is tripped (opened) and the generator is allowed to increase in speed freely, until it reaches the Vz value (break down voltage) of the zener diode. The present example uses a 10V zener diode, which keeps the maximum voltage below the rating of the generator (which is 14V in the present case). When triggered, the zener diode drops 10V across it, and presents an increasing voltage (climbing from zero initially, as it triggered at 10V, and drops 10V) across the red warning LED. This continues to climb until the forward voltage (Vf) of the warning LED is reached (typically around 2V for a low-cost, red LED). Once this forward voltage is reached, the warning LED starts to draw current, and lights, meaning the generator is now running at a 12V speed, (Vz+Vf) and the red LED is illuminated to tell the user they have exceeded the maximum weight rating of the system. This functionality occurs in fractions of a second.

In summary of the operation of the circuit of this third example, most of the time, the unit has the on-board LED and outlet terminals 13 (or socket) in the circuit in whichever mode of operation the user may have chosen. If too much force is present at the hanging point, the electrical connection to the normal circuit branch 70 is broken and the mass drop-speed is allowed to run away, until the protection circuit branch 72, which has been in parallel, but dormant, triggers to give a new electronic load across the generator, at a preset faster speed (which is now the top speed), illuminating a warning light. This creates a “back EMF” within the DC motor M, which ensures the ultimate speed remains below any damaging or dangerous overspeed condition.

If a ‘no electronic load’ condition arises during normal operation, this same circuit responds in the same manner, as it is not switched ‘to’ by the hanging turret switch 56, rather it is in parallel to the normal, functional electronic loads all of the time.

The protection system of each of the second and third examples provides a very low cost solution, with the third example arrangement providing the greatest performance in terms of sophistication, versatility, safety, and user friendliness.

Two key dangers present the highest risk to the system failing: too much load (temporary or sustained) on the gear teeth and too much speed at the fast end (output end) of the gear train. The third example protects against these in the following manner:

Too Much Load—Shock load:

This overload condition will strip gear teeth catastrophically in the gear train, or cause them to “skip”, which can jam the gearbox. This danger is countered by the internal spring 51 at the hanging point dampening the magnitude of the shock load to the teeth.

### Too Much Load for Too Long—Overweight:

This overload condition will have the same effect as the shock load, but the peak magnitude will be less (in general). For a very short duration, gear teeth (regardless of the material, be they metal or plastic) can withstand a high load. As the high load is applied, the teeth will be stressed, and will start to deform (strain). The extent of the strain is critical, and is determined by the duration of the loading and magnitude of the force. The longer the load is applied, the more the teeth strain, and there is a point beyond which the elastic deformation limit (the deformation point beyond which the teeth cannot recover to their original form) of the teeth is passed. Once this limit has been passed, the teeth will either fail (shear) or be plastically (permanently) deformed.

Allowing a controlled increase in the speed of the system is a counterintuitive solution to protecting the system. It assists in two ways. Firstly, it reduces the duration of the overloading on the teeth, so the deformation can be kept within elastic limits. Secondly, the load “seen” by any tooth is reduced because the resistance to rotation of the gearbox is reduced (the reverse torque is lowered). Thus the drive force experienced by the electrical energy-generating device is reduced.

### Overspeed:

The enhanced drive arrangement (in plastic and rubber) with the stepped cone gear is susceptible to overspeed conditions since the heat generated can cause the plastic ‘cone’ to melt. This overload condition in the form of “overspeed” could happen if the system suddenly encounters a condition in which no electronic load is placed on the generator, for example if the LED 11 fails, if the output can be switched to ‘terminals only’ and there is nothing connected there at the time, or if a dummy object, or unwired plug is inserted to a switching socket (where insertion is designed to cause all power to be directed toward said socket).

With the zener diode protection circuit in parallel, these conditions are protected against, using the same components that actuate in response to the overweight or shock-load conditions.

We have found that the specific protection circuit described above in the third example, in combination with spring resilience at the mounting point, can provide a solution to the main potential causes of failure (overload and overspeed). This dual aspect of benefits to the arrangement provides significant benefits in protecting the operation of the system and allows the provision of certain functional options without adding complexity, cost and/or losses in efficiency.

1. A portable apparatus for generating electrical energy, the apparatus comprising:
a. an electrical energy-generating device for generating electricity in response to input mechanical action;
b. a gravity powered drive for supplying the said mechanical action to the electricity-generating device by the descent of a suspended mass under the force of gravity;
c. a protection system adapted to prevent a drive force experienced by the electrical energy-generating device due to the input mechanical action from exceeding a predetermined threshold as a result of an overload condition.

2. An apparatus according to claim 1, wherein the electrical energy-generating device comprises a gear train for converting a relatively low speed input from the gravity powered drive to a relatively high speed output.

3. An apparatus according to claim 1, wherein the electrical energy-generating device comprises an electrical generator selected from the group comprising an alternator, a direct current motor or a dynamo.

4. An apparatus according to claim 1, wherein the overload condition is representative of one or more of the application of a mass in excess of a predetermined magnitude or the uncontrolled descent of the mass.

5. An apparatus according to claim 1, wherein the protection system at least partially mechanically decouples the mechanical drive from the electrical energy-generating device.

6. An apparatus according to claim 1, wherein at least part of the protection system is positioned between the gravity powered drive and the electrical energy-generating device.

7. An apparatus according to claim 1, wherein the protection system comprises a frictional mechanism for causing a reduced drive force to be provided to the electrical energy-generating device during the overload condition.

8. An apparatus according to claim 7, wherein the frictional mechanism is a clutch or brake.

9. An apparatus according to claim 1, wherein at least part of the protection system is positioned at or adjacent a coupling point of the mass.

10. An apparatus according to claim 1, wherein the apparatus has a housing comprising an attachment member for attaching the apparatus to a support when in use, and wherein at least part of the protection system is positioned at or adjacent the attachment member.

11. An apparatus according to claim 1, wherein the protection system comprises a resiliently biased member.

12. An apparatus according to claim 1, wherein the protection system further comprises an extendable coupling comprising a coupling housing and a length of flexible material, configured to allow the controlled separation of a first part of the apparatus attached to one end of the flexible material with respect to a second part of the apparatus attached to the coupling housing in response to the overload condition.

13. An apparatus according to claim 12, wherein the extendable coupling further comprises a clutch which causes the flexible material to be deployed when in the overload condition.

14. An apparatus according to claim 12, wherein the extendable coupling comprises a spool of the flexible material.

15. An apparatus according to claim 1, wherein the protection system comprises protection circuitry electrically connected to the output of the electrical energy-generating device, the protection circuitry being configured to operate when in the overload condition so as to reduce the electrical load on the electrical energy-generating device thereby allowing the electrical energy-generating device to operate at a speed in excess of that at which it operates under normal conditions.

16. An apparatus according to claim 15, wherein the protection circuitry comprises a switch and a warning device connectable to the output of the electrical energy-generating device in response to the switch being operated.

17. An apparatus according to claim 16 wherein the warning device is series connected with a resistor.

18. An apparatus according to claim 16, wherein the switch is operable to connect the warning device to the electrical energy-generating device when in a first position and the switch is adapted to adopt the first position when the apparatus is in an overload condition.

19. An apparatus according to claim 8, wherein the switch is operable to connect an operational circuit to the electrical energy generating device when the switch is in a second position.

20. An apparatus according to claim 15, wherein the protection circuitry comprises a zener diode and a warning device connected to the output of the electrical energy-generating device.

21. An apparatus according to claim 20, wherein the protection circuitry is adapted such that current is caused to flow through the protection circuitry when an electrical potential difference across the electrical energy generating device exceeds a predetermined threshold.

22. An apparatus according to claim 20, further comprising a switch operable to connect an operational circuit to the electrical energy generating device.

23. An apparatus according to claim 16, wherein the protection circuitry comprises a warning LED and/or buzzer so as to signal the existence of the overload condition to the user.

24. An apparatus according to claim 15, wherein the protection system comprises a member which moves physically in the event of an overload condition and causes the operation of the protection circuitry.

25. A portable apparatus according to claim 1, wherein the electrical energy-generating device and gravity powered drive are provided as a unit, the gravity powered drive including a flexible sprocket belt to one end of which is coupled the weight when in use so as to provide the force for operation of the apparatus.

26. A kit comprising:
a. a portable apparatus according to claim 1,
b. a sprocket belt to form part of the gravity powered drive; and
c. a primary weight bag and a counterweight bag for attachment to respective ends of the sprocket belt.
